(19) United States
(12) Patent Application Publication
(10) Pub. No.: US 2025/0360592 A1
(43) Pub. Date: Nov. 27, 2025

(54) Hand-Held Power Tool

(71) Applicant: Robert Bosch GmbH, Stuttgart (DE)

(72) Inventors: Florian Esenwein, Leinfelden-Echterdingen (DE); Achim Trick, Filderstadt (DE); Daniel Barth, Leinfelden-Echterdingen (DE)

(21) Appl. No.: 18/867,775

(22) PCT Filed: Jun. 27, 2023
(86) PCT No.: PCT/EP2023/067372

§ 371 Date: Nov. 20, 2024

(30) Foreign Application Priority Data
Jun. 30, 2022 (DE) 10 2022 206 692.8
May 2, 2023 (DE) 10 2023 204 052.2

(51) Int. Cl. B24B 23/02

(52) U.S. Cl. CPC B24B 23/022

(57) ABSTRACT

The invention disclosure relates to a hand-held power tool with a drive unit which comprises a spindle unit, and with a locking unit for locking a spindle unit which is mounted, in particular, rotatably about a drive axis. It is proposed that the drive unit, in particular the spindle unit, may be oriented, in particular may be pre-centered, with respect to the locking unit, in particular by means of a magnetic force.

The invention relates to hand-held power tools according to the preamble of claim 1.

### PRIOR ART

DE 10 2013 212 250 A1 discloses a spindle locking device with at least one locking unit, which comprises at least one movably mounted locking element for locking a spindle in at least one direction, and which comprises at least one operating element for actuation of the locking element, wherein the spindle locking device has a movement activation unit for pretensioning of the locking element in a non-actuated position of the operating element in the direction of a locking position of the locking element.

### DISCLOSURE OF THE INVENTION

The invention aims to solve the problem of improving a hand-held power tool with simple design measures.

The problem is solved with a hand-held power tool with a drive unit which comprises a spindle unit, and with a locking unit for locking a spindle unit which is mounted, in particular, rotatably about a drive axis.

It is proposed that the drive unit, in particular the spindle unit, may be oriented, in particular may be pre-centered, with respect to the locking unit, in particular by means of a magnetic force, preferably by means of cogging torque.

In particular, the drive unit, in particular the spindle unit, may be oriented, in particular can be pre-centered, with respect to the locking unit, in particular by means of a magnetic and/or a mechanical force. In an orientation or pre-centering by means of a magnetic force, the drive unit, in particular the spindle unit, may be (pre-) set by means of a cogging torque or a change in the magnetic resistance as a function of the rotational position of the spindle unit (rotor) relative to the stator or the locking unit. When oriented by means of a mechanical force, the drive unit, in particular the spindle unit, may be turned by means of a contact or a force effect by the locking unit. In particular, the drive unit, in particular the spindle unit, may be turned such that the locking unit may engage with or lock the drive unit, in particular the spindle unit.

The drive unit, in particular the spindle unit, may be oriented, in particular oriented in such a way or pre-centered, with respect to the locking unit, that the drive unit, in particular the spindle unit, is movable from an unlocked state to a locked state by means of the locking unit, in particular while avoiding further orientation of the drive unit, in particular the spindle unit.

A hand-held power tool is preferably understood to mean a hand-held and/or hand-guided manual power tool and, preferably, an electric planer or an electric grinder. It is understood that other hand-held power tools regarded as appropriate to the invention by a person skilled in the art also come into consideration. The hand-held power tool may comprise a drive unit for an indirect or direct drive for an accessory device, in particular bolt-shaped, preferably a drilling tool or milling tool. The drive unit may comprise a spindle unit which, in particular, is movably mounted about a drive axis. The spindle unit may comprise a drive shaft element and an output shaft element. The drive shaft element may be designed as a motor shaft. The drive shaft element may, in particular, be rotationally fixed and/or interlocked and/or frictionally locked to the output shaft element and/or coaxially arranged. The hand-held power tool may comprise a control or regulating unit for controlling or regulating the hand-held power tool, in particular the drive unit. The hand-held power tool may comprise a tool holder for holding an accessory device. The tool holder may be rotatably mounted about an output axis. The tool holder may be drivable by means of the drive unit, e.g., in order to operate the accessory device. For this purpose, the hand-held power tool may comprise a gear unit. The gear unit may transfer a movement of the drive unit to the tool holder. To operate the hand-held power tool, an actuating element may be provided, which may be actuated, and in particular may be actuated in such a way that the hand-held power tool, in particular the drive unit, is placed in an operating state. In an actuating state, the drive unit may, e.g., be put into an operating state, in particular to drive the accessory device.

A locking unit is to be understood in particular as a unit that blocks movement of the spindle unit, in particular by means of an interlocking and/or force-locking connection. The locking unit may limit movement, in particular rotational movement, of the spindle unit. The locking unit may surround the drive unit, particularly in a locked state, circumferentially about the drive axis, particularly entirely.

In particular, the hand-held power tool may have an alignment unit which aligns the spindle unit with the locking unit, in particular by means of a magnetic and/or mechanical force.

As a result, the drive unit, in particular the spindle unit, may be in an idle state (standstill) or in a non-driven state, with respect to the locking unit such that the locking unit is movable from an unlocked state to a locked state.

Conventional locking units have the disadvantage that a spindle unit must be partially elaborately oriented to be moved from an unlocked state to a locked state by means of the locking unit. Even in the case of a locking unit aligning the spindle unit, it is not ensured that the spindle unit is set to a locked state.

In the present case, the cogging torques of the drive unit should be used to be able to achieve pre-centering of the spindle unit with respect to the locking unit. In particular, the spindle unit, in particular by means of the cogging torques, is to be pre-centered such that the locking unit locks the spindle unit, in particular surrounds it without moving or turning the spindle unit. A movement or rotation of the spindle unit may be limited to a predetermined angular range, with which it is possible to lock the spindle unit by means of the locking unit. The angular range may vary in a tolerance range of about to +/−4 degrees. Particularly in the case of a spindle unit with a hexagonal receptacle, there is good engagement of the locking unit with the spindle unit.

The cogging torque particularly results in a drive unit with a permanent magnet. Rotating the spindle unit in a non-energized state induces locking in phenomenon, which creates the sensation of periodic, restless rotation.

Locking in occurs due to the attraction of, in particular, each, permanent magnet of the spindle unit towards the cog poles. The cog poles are formed from magnetic materials and protrude towards the spindle unit. The cogging torque results from a resulting torque of the spindle unit relative to the cog poles. A magnitude and a direction of the cogging torque periodically depends on a rotational position of the spindle unit relative to the drive stator. A period is determined according to the least common multiple of a number of the magnetic poles (permanent magnets) and a number of the cog poles. For example, the period is 30 degrees (=360°/12) when four magnetic poles and six cog poles are used.

Depending on the rotational position, the drive unit has periodic equilibrium positions in which the net cogging torque T is equal to zero and the clockwise torque balances the counterclockwise torque. Equilibrium positions include stable equilibrium positions and unstable equilibrium positions, which alternate every 15 degrees, for example.

To the extent that the spindle unit is deflected into positions other than the stable or unstable equilibrium positions, the cogging torque forces the spindle unit to the nearest stable equilibrium positions.

Each drive unit with permanent magnets (magnetic motor) generates a cogging torque. In brushless drive units in particular, permanent magnets having a high magnetic force are used to create a greater cogging torque.

The dependent claims specify further advantageous embodiments of the hand-held power tool according to the invention.

It may be expedient for the drive unit, in particular the spindle unit, to be in a position oriented toward the locking unit when in an idle state. An idle state is to be understood in particular to mean an equilibrium position of the drive unit, in particular the spindle unit with respect to a drive stator. This allows the idle state of the drive unit or the spindle unit to be oriented toward the locking unit in order to optimally position the spindle unit for the locking unit and to be able to easily reach a locked state.

It may further be expedient for the drive unit, in particular the spindle unit, to be in a position oriented toward the locking unit in a plurality of idle states, wherein more than 30%, in particular more than 40%, preferably more than 45%, more preferably more than 50%, of the idle states of the drive unit, in particular the spindle unit, are in a position oriented toward the locking unit.

It may also be expedient for the drive unit, in particular the spindle unit, to be arranged in a position to be oriented toward the locking unit in a plurality of idle states, wherein more than 30%, in particular more than 40%, preferably more than 45%, more preferably more than 50%, of the idle states of the drive unit, in particular the spindle unit, are arranged in a position to be oriented toward the locking unit.

Furthermore, it may be expedient for the drive unit, in particular the spindle unit, to have 12 idle states. In particular, the drive unit, in particular the spindle unit, is arranged in an oriented position in 6 out of 12 idle states. Preferably, the drive unit, in particular the spindle unit, is arranged in a position to be oriented in 6 out of 12 idle states.

It may further be expedient for the drive unit, in particular the spindle unit or a drive stator, to comprise a permanent magnet. In particular, a permanent magnet is a body that generates and maintains a magnetic field in its environment for a long time. Preferably, the permanent magnet is formed from a material, such as iron, cobalt, nickel, certain ferrites, or an alloy, or a combination thereof. The permanent magnet may maintain a magnetic field, in particular a permanent magnetic field, without having to use electrical power. The permanent magnet may have one or more north and south poles on its surface. It is to be understood that those skilled in the art select the permanent magnets used for the purpose of the present invention.

By this, it may be ensured that the spindle unit is oriented with respect to the locking unit in a predetermined position.

Further, it may be expedient for the drive unit, in particular the drive stator or the spindle unit, to comprise sheets of metal with a winding groove, wherein the winding groove extends parallel and/or rectilinearly with respect to the drive axis. The drive stator and/or the spindle unit may comprise a singularity or a plurality of winding grooves. The winding grooves may be configured to receive an electrical conductor, for example, particularly an insulated wire or braided wire to form a coil. It is to be understood that the winding grooves may be provided for forming a singularity or a plurality of pole shoes. The pole shoe has a high permeability. The pole shoe may be provided to allow magnetic field lines to protrude and spread in a defined shape by means of a permanent magnet or winding. As a result, a magnetic exciter field may be distributed circularly to the drive rotor by a pole shoe.

It may be expedient for the drive unit, in particular the drive stator or the spindle unit, to have 4, 6, 8, 10, 12 or 18 winding grooves.

Furthermore, it may be expedient for the spindle unit to have a flat area for limiting a movement of the spindle unit in a locked state of the locking unit. In particular, the number of the flat areas is less than the number of drive unit.

Furthermore, it may be expedient for the flat area to have an even surface. The even surface may be circumferentially bounded about the drive axis by a first boundary edge and by a second boundary edge.

It is further proposed that the spindle unit has a flat area for limiting a movement of the spindle unit in a locked state of the locking unit. In particular, the flat area has an even surface. The surface may be bounded, in particular in a radial direction to the drive axis, by an inner boundary circle about the drive axis. The surface may be bounded, in particular in a radial direction to the drive axis, by an outer boundary circle about a drive axis. The surface may be circumferentially bounded about the drive axis by a first radial plane and by a second radial plane. The first radial plane may have an angle of more than 35°, in particular more than 40°, preferably more than 50°, more preferably more than 60°, particularly preferably more than 80°, and/or less than 150°, in particular less than 110°, preferably less than 90°, more preferably less than 70°, particularly preferably less than 50°, with respect to the second radial plane.

The flat area may be formed on the spindle unit, in particular on an output shaft element.

It is proposed that the flat area has two, four, six or eight even surfaces. The even surfaces may be arranged adjacently one another. Each of two adjacent surfaces may be circumferentially bounded by a common boundary edge. The even surfaces may form a square, hexagonal, or octagonal receptacle.

The number of the flat areas may be less than the number of winding grooves in the drive stator. Ideally, the spindle unit may have a number of flat areas corresponding to the number of winding grooves. Cogging torques depend on the number of grooves on the stator.

It is further suggested that the flat area, in particular an even surface of the flat area, is oriented substantially parallel to an axis of movement of the locking unit in an idle state of the drive unit, in particular the spindle unit. In an oriented position, the flat area, in particular an even surface of the flat area, is arranged parallel to an axis of movement of the locking unit.

It may be expedient for the locking unit to comprise a locking element, which is movably mounted in a transverse direction with respect to the spindle unit, in particular perpendicular to the spindle unit. An axis of movement of the locking element may intersect a drive axis and may be arranged in particular perpendicular to that axis.

It may be expedient for the locking unit to comprise a locking element having a first locking area and a second locking area at an angle with respect to the first locking area.

Furthermore, it may be expedient for the first locking area to have a first locking edge, particularly formed in a straight line and the second locking area to have a second locking edge, particularly formed in a straight line, wherein the first locking edge is at an angle with respect to the second locking edge.

Furthermore, it may be expedient for the locking element to be movably mounted opposite the spindle unit along an axis of movement, which is arranged transversely, in particular perpendicularly to the drive axis.

Furthermore, it may be expedient for a section to intersect the axis of movement of the locking element, in particular the first locking area, transversely, in particular perpendicularly.

It is proposed that the spindle unit has a flat area for limiting a movement of the spindle unit in a locked state of the locking unit.

Furthermore, it may be expedient for the flat area to have an even surface that is circumferentially bounded around the drive axis by a first boundary edge and by a second boundary edge, wherein the first boundary edge abuts in a locked state against the first locking area and/or the second boundary edge abuts against the second locking area in a locked state.

It is further proposed that the flat area has an even surface, which is bounded by an inner boundary circle and an outer boundary circle around a drive axis, wherein the locking element, in particular the first locking area, is arranged in an unlocked state, in particular along an axis of motion (BA), at a height between the inner boundary circle and the outer boundary circle. A section transverse, in particular perpendicular, to the axis of movement may intersect in an unlocked state the first locking area and the flat area, in particular two even surfaces of the flat area, of the spindle unit.

It may be expedient for the outer boundary circle to have an outer diameter of greater than 1, in particular greater than 1.2, preferably greater than 1.4, more preferably greater than 1.6, most preferably greater than 1.8, and/or less than 2.2, in particular less than 2.0, preferably less than 1.8, more preferably less than 1.6, with respect to a maximum movement of the locking element along the axis of motion.

Furthermore, it may be expedient for the flat area to have an even surface, which in a locked state is overlapped by the locking unit in the circumferential direction about the drive axis by less than 60%, in particular less than 50%, preferably less than 40%, particularly preferably less than 30%. A particularly compact locking unit may thus be achieved, in that the spindle unit or the flat area is only movably mounted in an overlap required to ensure the locked state, so that a large sliding movement may be avoided.

Furthermore, it may be expedient for the spindle unit to be rotatably mounted in a locked state in a range of angles of in particular greater than 5°, preferably greater than 10°, more preferably greater than 15°, most preferably greater than 20°, and/or particularly less than 50°, preferably less than 45°, more preferably less than 40°, most preferably less than 35°. A particularly compact locking unit may thus be achieved.

It is proposed that the locking unit comprises a further locking element having a first locking area and a second locking area at an angle with respect to the second locking area.

It is further proposed that the locking element and the further locking element be arranged on two opposite sides.

In a further development of the invention, it is proposed that the locking unit in a drive state of the spindle unit is located with respect to the spindle unit, in particular a rotational direction of the spindle unit, such that a change of the locking unit from an unlocked state to a locked state is prevented and/or damage is prevented.

Particularly in the case of a drive unit in a drive state, for example, the locking unit may be actuated due to a faulty operation (miss-use) of the hand-held power tool. Due to the drive state of the drive unit, the spindle unit, in particular the flat area, may run into the locking unit, in particular a locking element. Depending on a direction of rotation of the spindle unit, either a return impulse may be applied to the locking unit opposite the axis of movement of the locking unit, or there may be a thrust or impulse substantially transverse, in particular perpendicular, to the axis of movement of the locking unit. In the first case, the locking unit is merely “thrown back” and rattling occurs when the locking unit is operated continuously. In this case, the locking unit is only returned to the unlocked state due to the force effect opposed to the axis of movement. In the latter case, on the other hand, due to the force effect, the spindle unit may “eat into” the locking unit and damage it accordingly. As a result, the locking function of the locking unit may deteriorate.

It may be expedient for the locking unit to comprise a return element for returning the locking unit to the unlocked state, in particular in a drive state of the spindle unit. It may be expedient for the return element to be located on the locking unit such that a change of the locking unit from an unlocked state to a locked state during an operating state of the spindle unit is prevented. It may be expedient for the return element to extend transversely, in particular perpendicularly, to an axis of movement of the spindle unit. In particular, the return element is configured as a stop. As a result, it may be ensured that a torque of the spindle unit leads to a movement of the return element opposite the axis of movement.

It may be expedient for the locking unit to comprise a first locking element. It may be expedient for the locking unit to comprise a second locking element. Preferably, the first locking element is located opposite the second locking element. Preferably, the return element is arranged on the first locking element. In particular, the return element restricts the first locking element, in particular along an axis of movement of the locking unit. Preferably, the return element and the first locking element are formed integrally with respect to one another. This allows a particularly compact design to be achieved.

It may be expedient for the first locking element and the second locking element to be spaced differently from the spindle unit, particularly along the axis of motion. It may be expedient for the first locking element to have a first distance to the spindle unit in an unlocked state. It may be expedient for the second locking element to have a second distance to the spindle unit, in particular to an axis. It may be expedient for the second distance to be greater than the first distance. It may be expedient for the second locking element to be offset back from a first locking element along an axis of movement of the locking unit. As a result, it may be ensured that a rotation of the spindle unit ends by hitting against the return element.

In the present invention, rotation of the drive unit is provided only in one rotational direction.

It may be expedient that a movement of the spindle unit in a locked state in the direction of movement, particularly in the direction of rotation, is limited by a first locking area. It may be expedient that movement of the spindle unit in a locked state contrary to the direction of movement, particularly against the direction of rotation, is limited by a second locking area. In particular, the first locking area is at an angle with respect to the second locking area. Preferably, the first locking area is located substantially between the return element and the second locking area. Thus, a separation of the functions on the one hand and on the other hand a secure locking function of the locking unit may be achieved in a particularly compact and reliable manner.

It may be expedient for the spindle unit, in particular an axis of the spindle unit, to be located in a locked state between the first locking element, in particular a first locking area of the first locking element, and the second locking element, in particular a first locking area of the second locking element.

It may be expedient that the first locking area of the first locking element is spaced apart from the first locking area of the second locking element, particularly along an axis of movement of the locking unit. In particular, the first locking area of the first locking element is arranged parallel to the first locking area of the second locking element.

It may be expedient for the spindle unit to have a flat area with a plurality of surfaces, wherein the locking elements are arranged in a locked state, in particular along the axis of movement, substantially between a first surface and a further surface facing away from the first surface, in particular a maximum extension of these surfaces. The first surface and the further surface may be arranged on opposite sides of the spindle unit. In particular, the first surface is arranged parallel to the further surface and/or spaced apart. A particularly compact locking unit may thus be achieved.

### BRIEF DESCRIPTION OF THE DRAWINGS

Further advantages follow from the description of the drawings below. Exemplary embodiments of the invention are shown in the drawings. The drawings, the description, and the claims contain numerous features in combination. A person skilled in the art will appropriately also consider the features individually and combine them into additional advantageous combinations. The drawings show:

FIG. 1 a perspective view of the hand-held power tool,

FIG. 2 a perspective view of a further hand-held power tool,

FIG. 3 a perspective view of a spindle unit,

FIG. 4 a sectional view through the spindle unit of FIG. 3 and

FIGS. 5 to 9 each a sectional view through the hand-held power tool,

FIG. 10 two exemplary cross-sectional views through the locking unit,

FIG. 11 two further sectional views through the locking unit,

FIG. 12 further sectional views through the locking unit.

In the following figures, like components are provided with like reference numerals.

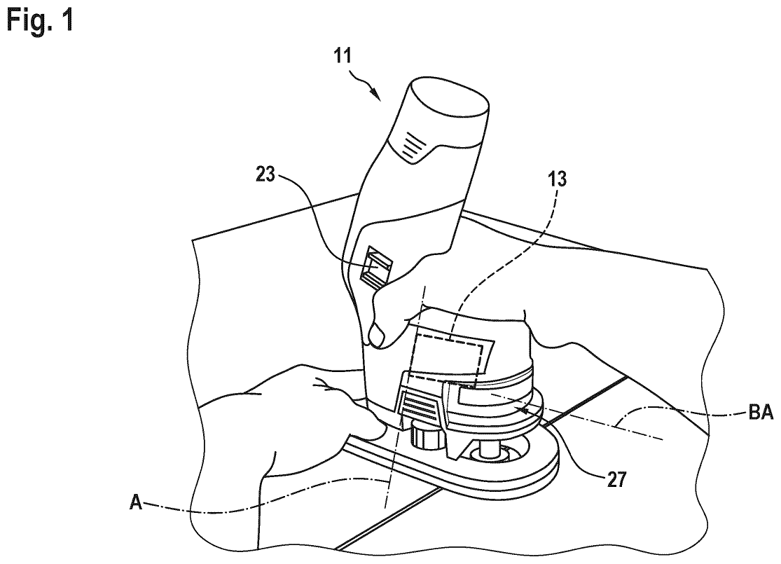

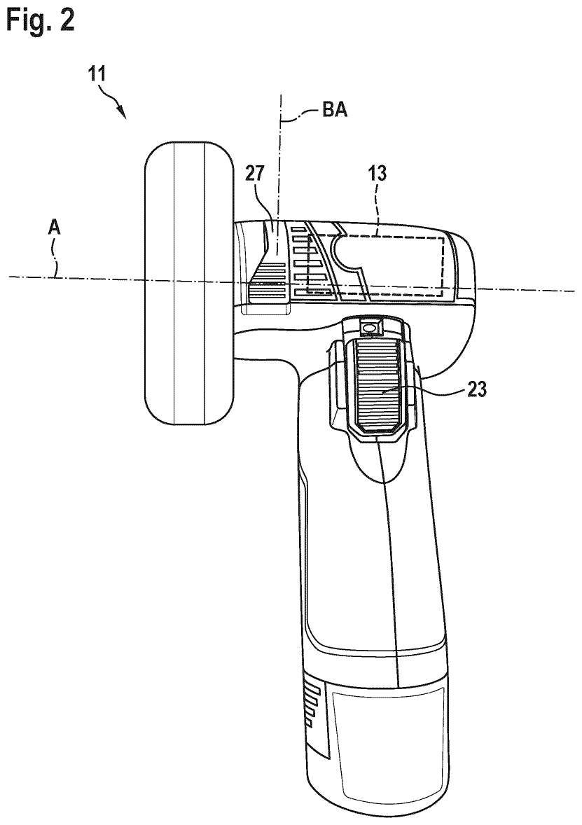

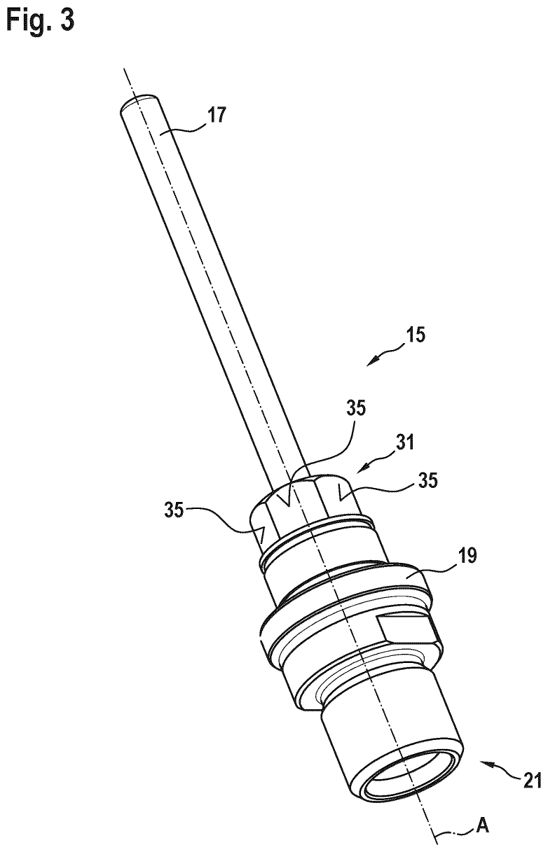

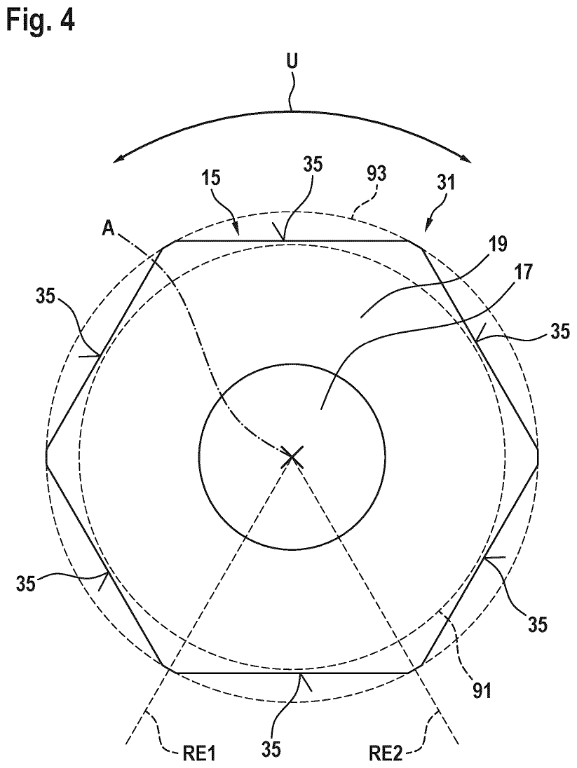

In FIG. 1 and FIG. 2, a hand-held power tool 11 for manual or manual processing of a work piece is shown. The hand-held power tool 11 is handheld and/or hand-guided as an electric planer (FIG. 2) or an electric grinder (FIG. 1). It is understood that other hand-held power tools 11n regarded as appropriate to the invention by a person skilled in the art also come into consideration. The hand-held power tool 11 comprises a drive unit 13 for an indirect or direct drive for an accessory device (not shown), in particular bolt-shaped, preferably a drilling tool or milling tool. The drive unit 13 comprises a spindle unit 15 which is movably mounted about a drive axis A, which comprises a drive shaft element 17 configured as a motor shaft and an output shaft element 19 configured as a tool holder 21. The drive shaft element 17 is, in particular, rotationally fixed and/or interlocked and/or frictionally locked to the output shaft element 19 and/or coaxially arranged with respect to it. The hand-held power tool 11 comprises a control unit or regulating unit for controlling or regulating the drive unit 13. To receive an accessory device, the hand-held power tool 11 comprises a tool holder 21, which is rotatably mounted about an output axis. The tool holder 21 may is operable by means of the drive unit 13, e.g., in order to operate the accessory device. The handheld power tool 11 may include a gear unit (not shown or absent) to transfer a movement of drive unit 13 to tool holder 21. To operate the hand-held power tool 11, an actuating element 23 is provided, which may be actuated, and in particular may be actuated in such a way that the hand-held power tool 11, in particular the drive unit 13, is placed in an operating state. In an actuating state, the drive unit 13 is put into an operating state, in particular to drive the accessory device.

The hand-held power tool 11 comprises a locking unit 27 for locking a spindle unit 15 rotatably mounted about a drive axis A. The locking unit 27 blocks movement of the spindle unit 15 by means of interlocking and connection of the locking unit 27 to the spindle unit 15. The locking unit 27 limits rotational movement of the spindle unit 15 in a locked state. The locking unit 27 completely surrounds the drive unit 13 in a locked state in the circumferential direction U about the drive axis A.

The spindle unit 15 may be oriented or pre-centered with respect to the locking unit 27. The spindle unit 15 may be oriented or pre-centered with respect to the locking unit 27 by means of a magnetic and/or a mechanical force. The spindle unit 15 is oriented or pre-centered with respect to the locking unit 27 such that the spindle unit 15 is movable from an unlocked state to a locked state by means of the locking unit 27 while avoiding further alignment of the spindle unit 15.

The spindle unit 15 is arranged in an idle state in a position toward the locking unit 27.

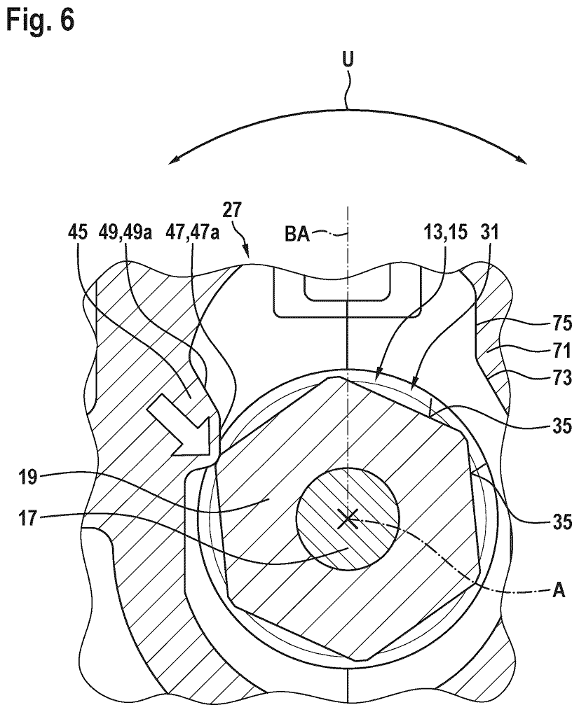

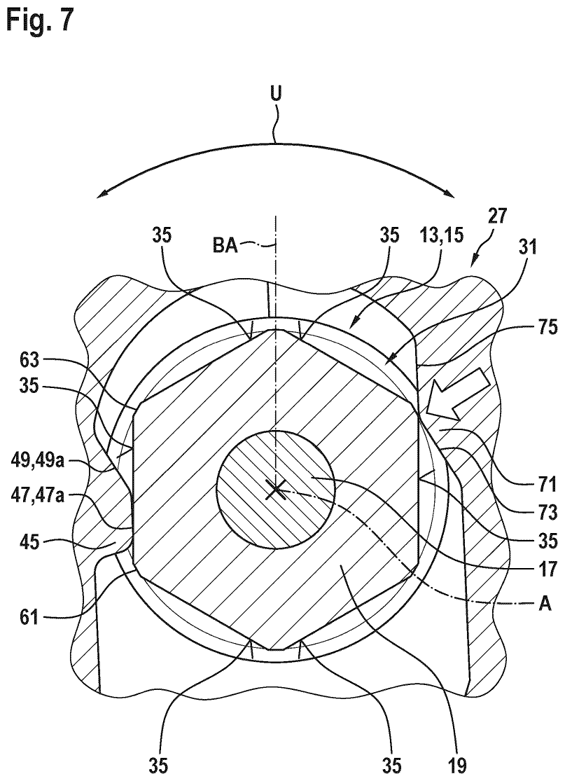

The spindle unit 15 is arranged in a plurality of idle states in a position oriented toward the locking unit 27, with 50% of the idle states of the spindle unit 15 being arranged in a position oriented toward the locking unit 27 (FIGS. 6-7).

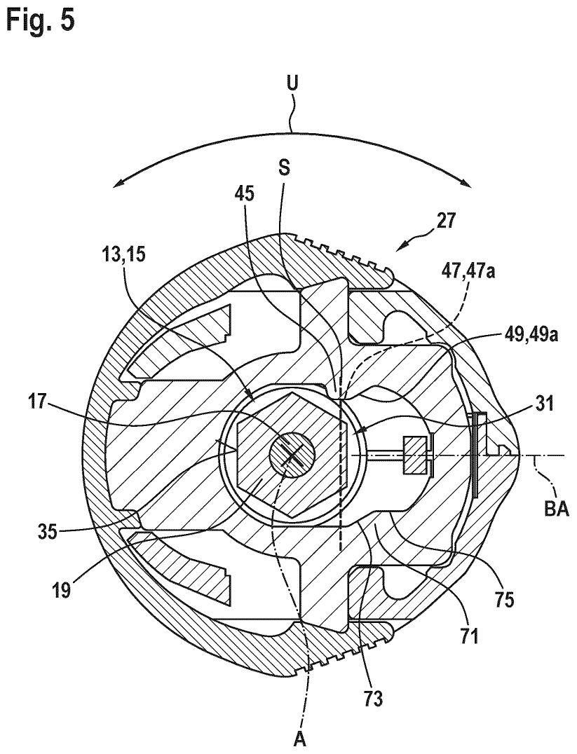

The spindle unit 15 is arranged in a plurality of idle states in a position to be oriented toward the locking unit 27, wherein 50% of the idle states of the spindle unit 15 are arranged in a position to be oriented toward the locking unit 27 (FIG. 5).

The spindle unit 15 has 12 idle states. The spindle unit 15 is arranged in an oriented position in 6 out of 12 idle states and a position to be oriented in 6 out of 12 idle states.

The spindle unit 15 comprises a permanent magnet 101. The permanent magnet 101 maintains a permanent magnetic field. It is to be understood that those skilled in the art select the permanent magnets used for the purpose of the present invention.

The drive stator or the spindle unit 15 comprises a set of metal sheets with a plurality of winding grooves 103, wherein the winding groove, in particular each groove, extends in parallel and rectilinear to the drive axis A. The winding grooves 103 are configured to receive an electrical conductor known to a person skilled in the art, such as in the form of an insulated wire, for forming a coil.

The drive stator or spindle unit 15 has 4, 6, 8, 10, 12 or 18 winding grooves 103.

The spindle unit 15 has a flat area 31 to limit a movement of the spindle unit 15 in a locked state of the locking unit 27.

The flat area 31 has an even surface 35, which is bounded in the circumferential direction U about the drive axis A by a first boundary edge 87 and by a second boundary edge 89.

The flat area 31 has an even surface 35, which is bounded in a radial direction to the drive axis A by an inner boundary circle 91 and an outer boundary circle 93 about a drive axis A. The surface 35 in the circumferential direction U about the drive axis A is bounded by a first radial plane RE1 and by a second radial plane RE2. The first radial plane RE1 has a 60° angle to the second radial plane RE2.

The flat area 31 is configured on the spindle unit 15 and the output shaft element 19, respectively.

The flat area 31 has 2, 4, 6 or 8 even surfaces 35, which are arranged adjacently to each other. Each of two adjacent surfaces 35 is bounded in the circumferential direction U by a common boundary edge. The even surfaces 35 form a hexagonal receptacle.

The number of the flat areas 31 is less than the number of winding grooves 103 in the drive stator.

Two even surfaces 35 of the flat area 31 are each oriented in an idle state of the spindle unit 15 substantially parallel to an axis of movement BA of the locking unit 27. In an oriented position, two even surfaces 35 of the flat area 31s are arranged parallel to an/the axis of movement BA of the locking unit 27. In a non-oriented position, each even surface 35 of the flat area 31s is angled relative to the axis of movement BA of the locking unit 27.

The locking unit 27 comprises a locking element 45, which is movably mounted with respect to the spindle unit 15 in a direction perpendicular to the spindle unit 15. The axis of movement BA of the locking element 45 intersects a drive axis A and is arranged perpendicularly to that drive axis A.

The locking unit 27 includes a locking element 45 having a first locking area 47 and a second locking area 49 at an angle with respect to the first locking area 47.

The first locking area 47 has a rectilinear first locking edge 47a and the second locking area 49 has a rectilinear second locking edge 49a. The first locking edge 47a is at an angle with respect to the second locking edge 49a.

The locking element 45 is movably mounted with respect to the spindle unit 15 along an axis of movement BA, which is arranged perpendicularly to the drive axis A.

A section perpendicular to the axis of movement BA intersects the locking element 45, in particular the first locking area 47, and the flat area in an unlocked state in each rotational position of the spindle unit 15.

The spindle unit 15 has a flat area 31 to limit a movement of the spindle unit 15 in a locked state of the locking unit 27.

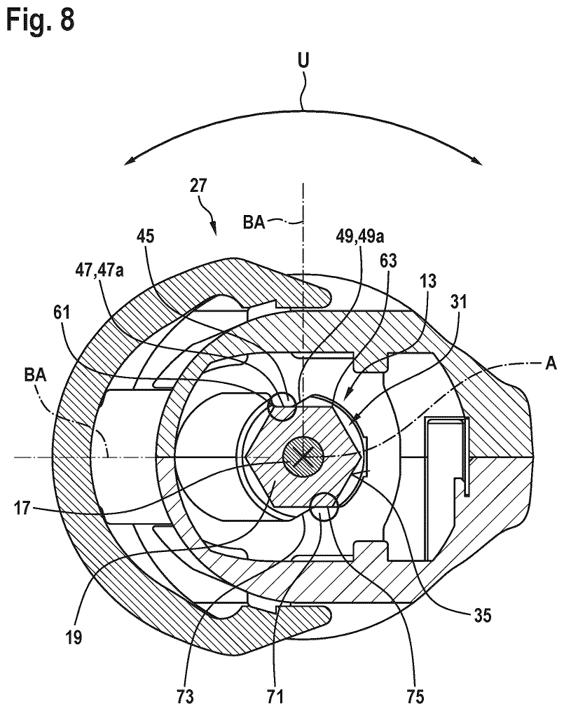

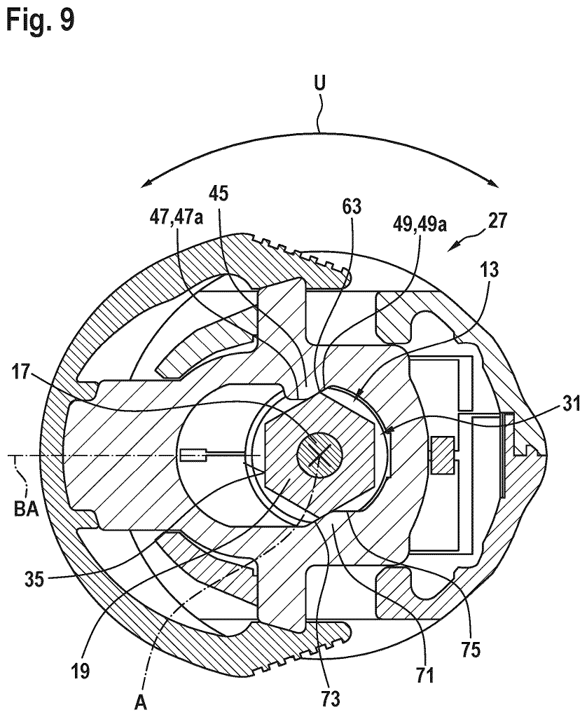

The flat area 31 has an even surface 35, which is bounded in the circumferential direction U about the drive axis A by a first boundary edge 61 and by a second boundary edge 63. The first boundary edge 61 abuts in a locked state against the first boundary region 47 (FIG. 8) and the second boundary edge 63 abuts in a locked state against the second boundary region 49 (FIG. 9).

The flat area 31 has an even surface 35, which is bounded by an inner boundary circle 91 and an outer boundary circle 93 around a drive axis A. The first locking area 47 is arranged in an unlocked state along an axis of movement (BA) at a height between the inner boundary circle 91 and the outer boundary circle 93. A section(S) transverse, in particular perpendicular, to the axis of movement may, in an unlocked state, intersect the first locking area and the flat area, in particular two even surfaces of the flat area, of the spindle unit.

The outer boundary circle 93 has an outer diameter along the axis of motion BA of approximately 1.8 with respect to the maximum movement of the locking element 45.

The flat area 31 has an even surface 35 in a locked state, less than 40% of which is overlapped by the locking unit 27 in the circumferential direction U about the drive axis A.

The spindle unit 15 is rotationally mounted in a locked state in an angular range of approximately 35°.

The locking unit 27 comprises a further locking element 71 having a first locking area and a second locking area angled relative to the second locking area. The locking element 45 and the further locking element 71 are located on two opposite sides. Preferably, the first locking element is arranged opposite the further and second locking elements, respectively.

The locking unit, in a drive state of the spindle unit, is located with respect to a rotational direction of the spindle unit, such that a change of the locking unit from an unlocked state to a locked state is prevented and/or damage is prevented. The locking unit comprises a return element 81 for returning the locking unit to an unlocked state in a drive state of the spindle unit. The return element 81 is located on the locking unit such that a change of the locking unit from an unlocked state to a locked state during an operating state of the spindle unit is prevented. The return member 81 extends substantially perpendicularly to the axis of movement of the spindle unit. The return element 81 is configured as a stop. The return element 81 is located on the first locking element and limits the first locking element along an axis of movement BA of the locking unit. The return element 81 and the first locking element are formed integrally with respect to one another.

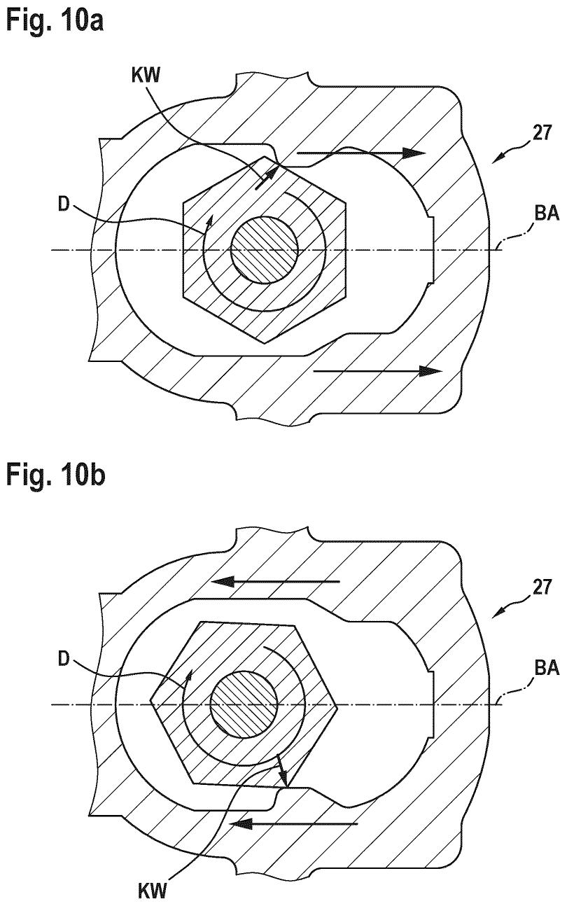

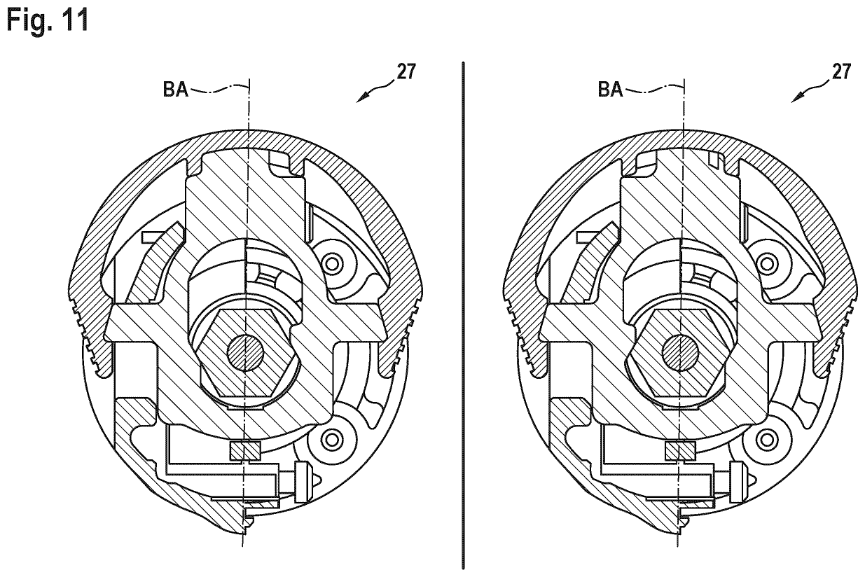

Particularly when the drive unit is actuated, for example, due to a faulty operation (miss-use) of the hand-held power tool while the drive unit is rotating, the spindle unit, in particular the flat area, may run against the locking unit, in particular a locking element due to the drive state of the drive unit. Depending on a direction of rotation of the spindle unit, either a return impulse may be applied to the locking unit opposite the axis of movement of the locking unit, or there may be a thrust or impulse substantially transverse, in particular perpendicular, to the axis of movement of the locking unit. In the first case, the locking unit is merely “thrown back” and rattling occurs when the locking unit is operated continuously (FIG. 10a). In this case, the locking unit is only returned to the unlocked state due to the force effect opposed to the axis of movement. In the latter case, on the other hand, due to the force effect, the spindle unit may “eat into” the locking unit and damage it accordingly (FIG. 10b). Accordingly, proper installation of the locking unit relative to the spindle unit is to be ensured. In particular, erroneous installation should be preventing by using poke yoke, such that the locking unit comprises an asymmetrically formed tongue element, which is intended to prevent erroneous installation. The tongue element is connectable to the c-shaped actuating element, which receives the tongue element, only when properly in the correct positions (FIG. 11).

The first locking element and the second locking element are spaced differently from the spindle unit along the axis of motion. The first locking element has a first distance to the spindle unit in an unlocked state, and the second locking element has a second distance to the spindle unit relative to an axis, wherein the second distance is greater than the first distance. The second locking element is offset back from a first locking element along an axis of movement of the locking unit.

In the present invention, rotation of the drive unit is provided only in one rotational direction D.

A movement of the spindle unit in a locked state in the direction of rotation D is limited by a first locking area. A movement of the spindle unit in a locked state opposite the direction of rotation D is limited by a second locking area. The first locking area of the first locking element is at an angle with respect to the second locking area. The first locking area is substantially located between the return element 81 and the second locking area.

An axis A of the spindle unit 13 is located in a locked state between the first locking area of the first locking element 47 and the first locking area of the second locking element 75.

The first locking area 47 of the first locking element 45 is spaced apart along an axis of movement BA of the locking unit 27 from the first locking area 75 of the second locking element 71. The first locking area 47 of the first locking element 45 is arranged parallel to the first locking area 75 of the second locking element 71.

The spindle unit has a flat area with a plurality of surfaces, wherein the locking elements are arranged in a locked state, in particular when viewed along the axis of movement BA, substantially between a first surface and a further surface facing away from the first surface, in particular a maximum extension of these surfaces. The first surface and the further surface may be arranged on opposite sides of the spindle unit. In particular, the first surface is arranged parallel to the further surface and/or spaced apart. A particularly compact locking unit may thus be achieved.

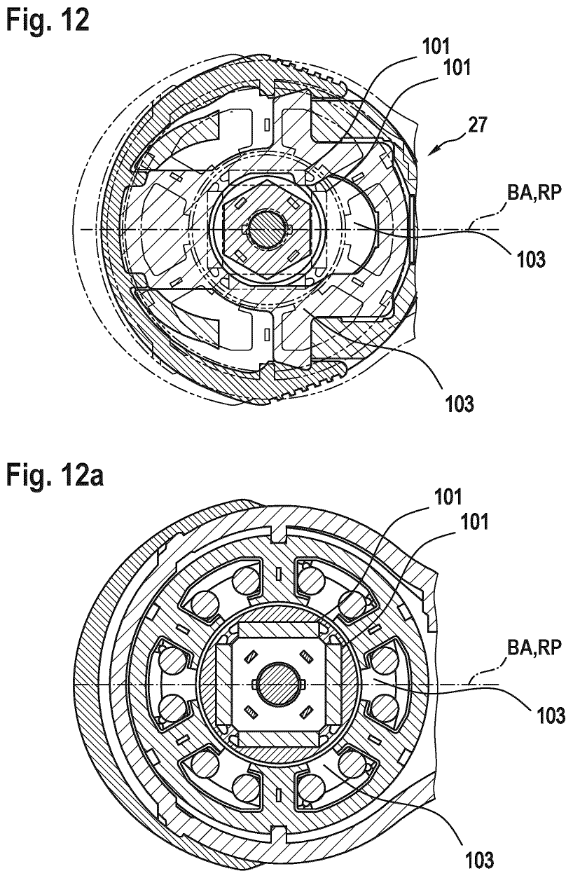

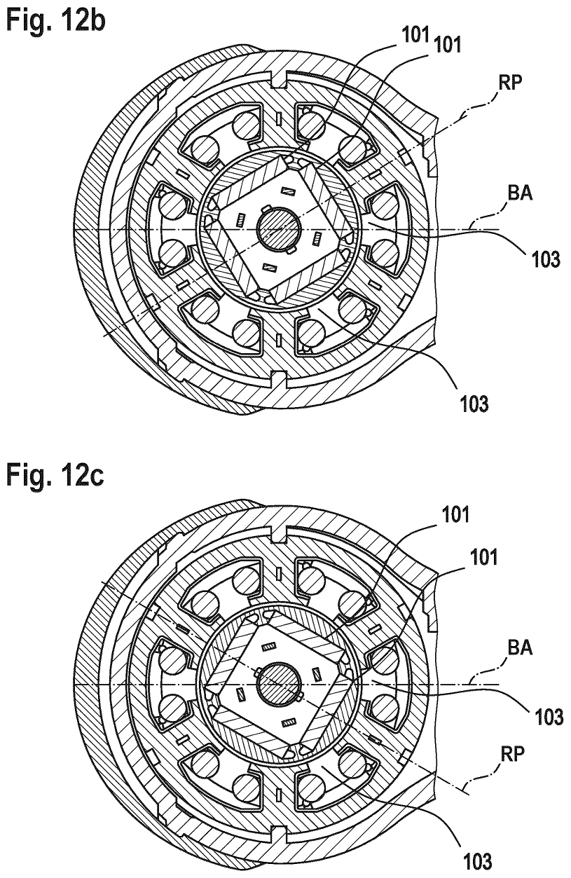

FIG. 12 shows a section through the spindle unit. In the section, the cog poles of the drive stator and the permanent magnets 101 of the spindle unit are indicated. The idle position RP is arranged parallel to the axis of movement BA.

A section through the drive unit is shown in FIG. 12a. The arrangement of the drive stator with respect to the spindle unit corresponds to the arrangement of FIG. 12.

In FIGS. 12b and 12c, the idle position RP is pivoted about +30 degrees and about −30 degrees relative to the axis of motion BA.

1. A hand-held power tool, comprising:
a drive unit which comprises a spindle unit; and
a locking unit configured to lock a spindle unit, which is mounted, about a drive axis, wherein
the spindle unit is configured to be pre-centered, with respect to the locking unit, by a cogging torque.

2. The hand-held power tool according to claim 1, wherein the spindle unit, is arranged in an idle state in a position oriented toward the locking unit.

3. The hand-held power tool according to claim 1, wherein:
the spindle unit is arranged, in a plurality of idle states, in a position oriented toward the locking unit;
more than 50% of the idle states of the spindle unit are arranged in a position oriented toward the locking unit.

4. The hand-held power tool according to claim 1, wherein:
the spindle unit is arranged, in a plurality of idle states in a position oriented toward the locking unit;
more than 50% of the idle states of the spindle unit are arranged in a position oriented toward the locking unit.

5. The hand-held power tool according claim 1, wherein the spindle unit comprises a permanent magnet.

6. The hand-held power tool according to claim 1, wherein:
the spindle unit comprises a flat area configured to limit a movement of the spindle unit in a locked state of the locking unit;
the flat area has an even surface which is bounded by an inner boundary circle and an outer boundary circle about a drive axis; and
the first locking area is arranged in an unlocked state along an axis of motion, at a height between the inner boundary circle and the outer boundary circle.

7. The hand-held power tool according to claim 6, wherein:
the outer boundary circle has an outer diameter, with respect to a maximum movement of the locking element along the axis of motion, of greater than 1.6 of less than 2.2.

8. The hand-held power tool according to claim 6, wherein the flat area has an even surface less than 60% of which is overlapped by the locking unit circumferentially about the drive axis.

9. The hand-held power tool according to claim 1, wherein the spindle unit is mounted rotationally in a locked state in a range of angles of in particular more than 5° and in particular less than 50°.

10. The hand-held power tool according to claim 1, wherein the locking unit comprises a locking element having a first locking area and a second locking area at an angle with respect to the first locking area.

11. The hand-held power tool according to claim 10, wherein the locking unit comprises a further locking element having a first locking area and a second locking area at an angle with respect to the first locking area, wherein the locking element and the further locking element are arranged on opposite sides.

12. The hand-held power tool according to claim 1, wherein the locking unit is arranged in a drive state of the spindle unit with respect to a direction of rotation of the spindle unit such that a change of the locking unit from an unlocked state to a locked state is prevented and/or damage is reduced.

13. The hand-held power tool according to claim 1, wherein:
the locking unit comprises a return element configured to return the locking unit to a drive state of the spindle unit;
the return element is arranged on the locking unit, preventing the locking unit from changing from an unlocked state to a locked state during an operating state of the spindle unit; and
the return element is perpendicular to an axis of motion of the spindle unit.

14. The hand-held power tool according to claim 1, wherein
the locking unit comprises a first locking element and a second locking element, which is opposite to the first locking element; and
the first locking element and the second locking element are differently spaced from the spindle unit.

15. The hand-held power tool according to claim 1, wherein at least one of:
a movement of the spindle unit in a locked state in the rotational direction is limited by a first locking area;
a movement of the spindle unit in a locked state against the direction of rotation is limited by a second locking area;
an axis of the spindle unit is located, in a locked state, between a first locking area of the first locking element and a first locking area of the second locking element.
